(19) United States
(12) Patent Application Publication
(10) Pub. No.: US 2005/0146429 A1
(43) Pub. Date: Jul. 7, 2005

(54) Building occupant location and fire detection system

(76) Inventors: Michael Thomas Spoltore, Valley Stream, NY (US); Robert J. Orlando, Nesconset, NY (US); Robert S. Adonailo, Rockville Centre, NY (US)

Correspondence Address: HONEYWELL INTERNATIONAL, INC.;LAW DEPARTMENT, 101 COLUMBIA ROAD, MORRISTOWN, NJ, 07692, US

(21) Appl. No.: 10/750,087

(22) Filed: Dec. 31, 2003

(51) Int. Cl. G08B 25/00

(52) U.S. Cl. 340/525; 340/573.4; 340/540

(57) ABSTRACT

A system and method for providing assistance to emergency personnel that includes the apparatus and method for detecting the presence of personnel within a protected premises, apparatus for detecting an imminent threat selected from the group consisting of a fire, seismological and terrorist events and apparatus, responsive to the means for detecting, for displaying the location of personnel within protected premises. The apparatus for detecting an imminent threat may include an ionization-type detector or a photoelectric detector or temperature sensing and may utilize fuzzy logic or Boolean logic. The temperature sensing apparatus may utilize one or more thermistors. The apparatus for detecting the presence of personnel may include ultrasonic apparatus, microwave apparatus, or infrared sensing. The apparatus for displaying the location of personnel within protected premises includes a floor plan on which the locations are defined and may include wireless apparatus for remotely displaying the location of personnel within protected premises.

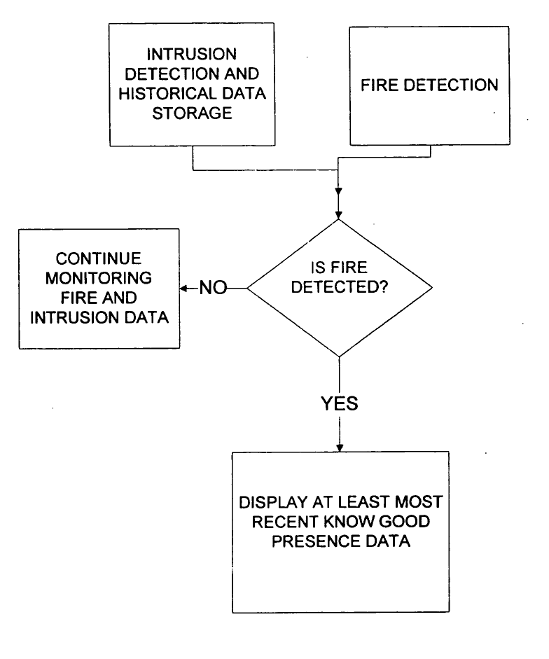

### BACKGROUND OF THE INVENTION

The invention relates to safety and security devices and methods and particularly to apparatus and methods for locating individuals in a building during an emergency. One such emergency situation may occur during a fire.

Establishing the location of individuals within a building during a fire is critical to individuals that may be trapped in the building as well as to individuals seeking to rescue them. Many firefighters have died attempting to rescue individuals that have been reported might be in a building. It is particularly sad when a firefighter dies seeking to rescue an individual that is subsequently determined to have been in no danger.

U.S. Pat. No. 6,587,049 issued to Thacker on Jul. 1, 2003 states that several methods are known for manually signaling the wish not to be disturbed or the need for assistance by a person present in a given space as representatively disclosed by Winston (see, U.S. Pat. No. 3,964,058), Perka, et al. (see, U.S. Pat. No. 6,104,942) and Wagner, et al. (see, U.S. Pat. No. 6,236,303). However, these methods are limited by the possibility that the person present in the space may be unable to perform the manual activity required to activate the desired signals or may neglect to do so.

Various methods are also known for employing a single motion sensor to detect occupancy in a space as representatively disclosed by Kamada (see, U.S. Pat. No. 4,679,034), Myllymaki (see, U.S. Pat. No. 5,640,141), and Vories, et al. (see, U.S. Pat. No. 5,861,806). However, these methods cannot reliably detect the presence of a person in a designated space since they may be activated by motion outside the designated space or by motion within the space that is caused by a source other than a person. Moreover, these methods cannot determine occupant status since they consider only one disclosed by Adolf, et al. (see, U.S. Pat. No. 5,785,347), Corrado, et al. (see, U.S. Pat. No. 6,026,340), and Breed, et al. (see, U.S. Pat. No. 6,081,757). However, these methods do not determine multiple passenger conditions or employ indicators to signal information about the passenger's status. Rather, they gather passenger data solely to confirm the presence of parameters related to deploying an airbag in a crash.

Relatively little attention has been focused on this problem despite substantial advances in the related technologies.

### SUMMARY OF THE INVENTION

It is an object of the present invention to provide an additional measure of safety both for building occupants as well as emergency workers such as firefighters.

More particularly, it is another object of the invention to provide rescue workers very specific information about the location of individuals within a building.

It is now been found that these and other objects of the invention may be attained in a system and method for providing assistance to emergency personnel that includes apparatus for detecting the presence of personnel within a protected premises, apparatus for detecting an imminent threat selected from the group consisting of a fire, seismological and terrorist events and apparatus, responsive to the means for detecting, for displaying the location of personnel within protected premises.

In some forms of the invention the system includes apparatus for storing the location of personnel within a protected premises that may include nonvolatile memory and may be capable of storing such data for a plurality of time periods.

The apparatus for detecting an imminent threat may include an ionization-type disclosed by Adolf, et al. (see, U.S. Pat. No. 5,785,347), Corrado, et al. (see, U.S. Pat. No. 6,026,340), and Breed, et al. (see, U.S. Pat. No. 6,081,757). However, these methods do not determine multiple passenger conditions or employ indicators to signal information about the passenger's status. Rather, they gather passenger data solely to confirm the presence of parameters related to deploying an airbag in a crash.

Relatively little attention has been focused on this problem despite substantial advances in the related technologies.

### SUMMARY OF THE INVENTION

It is an object of the present invention to provide an additional measure of safety both for building occupants as well as emergency workers such as firefighters.

More particularly, it is another object of the invention to provide rescue workers very specific information about the location of individuals within a building.

It is now been found that these and other objects of the invention may be attained in a system and method for providing assistance to emergency personnel that includes apparatus for detecting the presence of personnel within a protected premises, apparatus for detecting an imminent threat selected from the group consisting of a fire, seismological and terrorist events and apparatus, responsive to the means for detecting, for displaying the location of personnel within protected premises.

In some forms of the invention the system includes apparatus for storing the location of personnel within a protected premises that may include nonvolatile memory and may be capable of storing such data for a plurality of time periods.

The apparatus for detecting an imminent threat may include an ionization-type detector or a photoelectric detector or temperature sensing and may utilize fuzzy logic or Boolean logic. The temperature sensing apparatus may utilize one or more thermistors. Some forms of the apparatus in accordance with the invention may include structure for determining the last known good position information.

The apparatus for detecting the presence of personnel may include ultrasonic apparatus, microwave apparatus, infrared sensing or a combination of both passive infrared and microwave sensors.

The decision-making process in the apparatus may be achieved when a logic circuit or a microprocessor. The apparatus for displaying the location of personnel within protected premises may include a floor plan on which the locations are defined and may include wireless apparatus for remotely displaying the location of personnel within protected premises.

A method for providing assistance to emergency personnel which includes detecting the presence of personnel within a protected premises, detecting an imminent threat selected from the group consisting of a fire, seismological and terrorist events, displaying the location of personnel within protected premises when an imminent threat is detected, further including the step of storing the location of personnel within protected premises, wherein the step of storing the location of personnel is achieved with nonvolatile memory.

The method for providing assistance to emergency personnel includes the step of storing the location of personnel for personnel within a protected premises for each of a plurality of time periods. The method for providing assistance to emergency personnel includes providing apparatus that includes a providing one such apparatud selected from the group that includes (a.) ionization-type detector, (b) a photoelectric detector, (c) fuzzy logic, (d) Boolean logic, (e) temperature sensing, (f) ultrasonic apparatus, (g) at least one thermistor, (h) microwave apparatus and (i) infrared sensing.

### BRIEF DESCRIPTION OF THE DRAWING

The invention will be better understood by reference the accompanying drawing illustrating schematically the system in accordance with one form of the present invention.

### DESCRIPTION OF THE PREFERRED EMBODIMENTS

Referring now to the FIGURE, there is shown a system and method in accordance with one form of the present invention. The building on which the system is installed includes a presence detection and historical data storage system 12 that is coupled to a fire/smoke detection system 14.

Known intrusion detection systems are inherently presence detection systems. For the present application it is preferable that the intrusion system include memory and storage apparatus for retaining some historical data regarding activity over a period of time. Thus, such intrusion apparatus is capable of utilizing historical information if real time information is not available. Examples of intrusion detection systems include those shown in the following United States patents having the same assignee as the present application:

| | |
|---|---|
| 6,593,850 | Wireless intrusion detector with test mode issued on Jul. 15, |
| | 2003 to Addy. |
| 6,188,318 | Dual-technology intrusion detector with pet immunity issued |
| | on Feb. 13, 2001 to Katz, et al. |
| 4,939,359 | Intrusion Detection System with Zone Location issued on Jul. |
| | 3, 1990 to Freeman. |
| 4,614,938 | Dual channel pyroelectric intrusion detector issued on Sep. |
| | 30, 1986 to Weitman. |
| 4,360,905 | Intrusion Alarm System for Use with Two-Wire-Cable issued |
| | on Nov. 23, 1982 to Hackett. |
| RE30,288 | Intrusion Detection System issued on May 27, 1980 to |
| | Hackett. |
| 4,035,798 | Ultrasonic Intrusion Detection System issued on Jul. 12, 1977 |
| | to Hackett |

Examples of such a fire/smoke detection system 14 include the apparatus shown in the following United States patents having the same assignee as the present application:

| | |
|---|---|
| 6,150,935 | Fire Alarm System With Discrimination Between Smoke And |
| | Non-Smoke Phenomena issued on Nov. 21, 2000 to |
| | Anderson; |
| 6,084,522 | Temperature Sensing Wireless Smoke Detector issued on Jul. |
| | 4, 2000 to Addy |
| 5,781,291 | Smoke Detectors Utilizing A Hydrophilic Substance issued on |
| | Jul. 14, 1998 to So, et al. |
| 5,764,142 | Fire Alarm System With Smoke Particle Discrimination issued |
| | on Jun. 9, 1998 to Anderson, et al. |
| 5,726,633 | Apparatus and Method for Discrimination of Fire Types |
| | issued on Mar. 10, 1998 to Wiemeyer; |
| 5,659,292 | Apparatus Including a Fire Sensor and a Non-Fire Sensor |
| | issued on Aug. 19, 1997 to Tice. |
| 5,633,501 | Combination Photoelectric and Ionization Smoke Detector |
| | issued on May 27, 1997 to Amieshi, et al. |
| 5,557,262 | Fire alarm System with Different Types of Sensors and |
| | Dynamic System Parameters issued on Sep. 17, 1996 |
| | to Tice. |
| 5,117,219 | Smoke and Fire Detection System Communication issued |
| | on May 26, 1992 to Tice, et al. |
| 4,916,432 | Smoke and Fire Detection System Communication issued |
| | on May 26, 1992 to Tice, et al. |
| 4,374,329 | Smoke Detector with Test Apparatus issued on Feb. 15, |
| | 1983 to Schoenfelder, et al. |
| 4,316,184 | Combination Combustion-Product Detector issued on |
| | Feb. 16, 1982 to Nagel. |
| 4,225,860 | Sensitivity Controlled Dual Input Fire Detector issued |
| | on Sep. 30, 1980 to Conforti. |
| 4,097,851 | Sensitivity Compensated Fire Detector issued on |
| | Jun. 27, 1978 to Klein. |
| 4,091,363 | Self-contained Fire Detector with Interconnection Circuitry |
| | issued on May 23, 1978 to Siegel, et al. |
| 4,020,479 | Fire Detector issued on Apr. 26, 1977 to Conforti, et al. |

The disclosures of the above referred to patents are incorporated by reference. Various embodiments of the present invention may utilize different fire and smoke detecting apparatus as well as different intrusion detection and storage apparatus.

The output of the intrusion detection and historical data storage preferably includes data regarding the location of each person in each room (and in some cases in each part of very large rooms). Similarly, the fire detection system includes preferably sensing means for detecting the location of each fire or smoke in each room (and some cases in each parts of very large rooms). Ideally, the fire detection system includes apparatus for discrimination between various types of fires as described in U.S. Pat. No. 5,726,633 (referred to above). That apparatus relies on the characteristics of the smoke to determine the type of fire producing smoke. As noted therein flaming fires exhibit quite different smoke characteristics than smoldering fires. As also noted therein the different types of smoke sensors respond differently depending on the fire type. Thus, photoelectric detectors are known to respond more rapidly to smoldering fires than are ionization-type detectors. Similarly, ionization-type detectors are known to respond more rapidly to flaming type fires than do photo-electric detectors. The same patent describes fuzzy logic and Boolean logic techniques for analysis of such data. As described in U.S. Pat. No. 6,084,522 (referred to above) temperature sensing in combination with a smoke detector is also useful. For example various embodiments may include a photoelectric sensor for determining the presence of smoke and a plurality of thermistors for providing a temperature signal reflective of a temperature level. Such detailed information is particularly desirable for an ideal fire occupancy system.

It is desirable that the historical data storage portion of the apparatus maintain location information over a period of time. This is significant because the apparatus sensing the location of personnel information may at some point been damaged so that no new location of personnel information will be produced. In such a situation it is important that the system can rely on the last known good information to produce the most accurate possible data to fire department personnel. The ideal fire occupancy system is also provided with detailed information from an intrusion detection system. Systems including ultrasonic apparatus are disclosed in U.S. Pat. No. 4,035,798 (referred to above) and Re 30,288 (referred to above). The latter patent also describes microwave intrusion detection systems. U.S. Pat. No. 6,188,318 (referred to above) describes intrusion detection apparatus and includes a passive infra red (PIR) sensor and a microwave sensor with processing apparatus to detect a human intruder and reject other noise producing sources. The processing is accomplished with a microprocessor.

The choice of circuitry for the logical step of concluding that a fire hazard condition exists and then displaying the occupants location is not critical. In one form of the invention the logic circuit performs a logical AND function. Thus, if both an intrusion and a fire is indicated a display of the least the last known good information is provided to fire department personnel. In other embodiments any indication of fire automatically produces a display for fire department personnel. In some cases the display will indicate that no one is present in the protected premises. It is of course highly desirable to provide this information for fire department personnel. Many fire department personnel have been injured or killed searching for individuals that have been falsely reported to be in a building. Thus, it is a vital concern that fire personnel are provided with accurate information to avoid endangering fire department personnel when no one is exposed to danger from the fire. Similarly, it is a vital importance that fire department personnel know the precise location of individuals within a protected premise.

The display of the location of personnel located within a protected premises is preferably available for fire department personnel and this is preferably accomplished by a wireless system. The display is also preferably communicated to a remote monitoring station or human personnel can observe evolving events. In some cases in may be desirable to transmit the location of personnel to “hardened” sites in the vicinity of the protected premises. In this context that term “hardened” is intended to refer to sites that are less vulnerable to a fire spreading throughout the protected premises.

The wireless communication may be accomplished using various wireless techniques as described in U.S. Pat. Nos. 6,026,165; 6,167,137; 6,201,472; and 6,208,694 (referred to above). In addition the display may be transmitted utilizing Wi-Fi 802.11 technology to wirelessly transmit the information to physically spaced locations. This approach allows the use of standardized technology and insurers that fire department personnel would have access at command posts at the protected premises or alternatively at each fire department apparatus located at the protected premises. Thus, even mobile fire engines, fire and police cars and other mobile apparatus may have a detailed display of the information. The same location information may also have application for other situations such as robberies, burglaries etc. Encryption measures may be employed to ensure that the information is not disclosed in a manner that would be prejudicial to the owner or manager of protected premises. Those skilled in the art will recognize that other systems for broadcasting such visual displays may also be utilized without departing from the spirit of the invention. For example, The Ademco Group of Honeywell International, Inc. manufactures graphic keypads that communicate with security panels. This combination allows a user at the graphic keyboard to selectively observe and/or listen to a plurality of zones within a protected premise. The display preferably includes a floor plan for a protected premises together, ideally, with the orientation thereof with respect to the North Pole as well as location of significant landmarks such as roads and the identification of such roads.

Although the description herein has referred to fire department personnel those skilled in the art will recognize that the apparatus in accordance with the present invention has application to other emergency situations. For example, other forms in the invention may include seismological monitoring equipment either in combination with the above described apparatus or as a substitute for the fire detection apparatus. The seismological monitoring equipment may include conventional sensing devices known in the art. The prior art includes various automobile and building alarms that rely on impact and/or concussion to initiate an alarm. While the sensitivity of such systems is not directly applicable for use with the present invention, those skilled in the art will recognize that the general type of sensors employed therein may be utilized to imitate the display of the occupants of a building. Such apparatus will have application in the event of earthquakes as well as acts of war or terrorism. For purposes of this application “seismological monitoring equipment” will be understood to include equipment that can detect major acts of war as well as terrorism in addition to earthquakes and related phenomenon and “seismological events” includes earthquakes and earthquake related phenomenon as well as major acts of warfare and terrorism.

The respective methods and systems in accordance with the present system may utilize a computer that includes a microprocessor and memory and which cooperates with software that is commercially available or within the skill of practitioners in the programming arts.

It will be obvious to those having skill in the art that many changes may be made to the details of the above-described embodiments of this invention without departing from the underlying principles thereof. Accordingly, it will be appreciated that this invention is also applicable to other systems. The scope of this invention should, therefore, be determined only by the following claims.

1. A system for providing assistance to emergency personnel which comprises:
means for detecting the presence of personnel within a protected premises;
means for detecting an imminent threat selected from the group consisting of fire, seismological and terrorist events;
means, responsive to the means for detecting, for displaying the location of personnel within protected premises.

2. A system for providing assistance to emergency personnel as described in claim 1 including apparatus for storing the location of personnel within protected premises.

3. A system for providing assistance to emergency personnel as described in claim 2 wherein said apparatus for storing location of personnel includes nonvolatile memory.

4. A system for providing assistance to emergency personnel as described in claim 3 wherein said apparatus for storing is capable of storing such data for a plurality of time periods.

5. A system for providing assistance to emergency personnel as described in claim 1 wherein said means for detecting an imminent threat includes an ionization-type detector.

6. A system for providing assistance to emergency personnel as described in claim 1 wherein said means for detecting an imminent threat includes a photoelectric detector.

7. A system for providing assistance to emergency personnel as describing claim 1 that utilizes fuzzy logic.

8. A system for providing assistance to emergency personnel as described in claim 1 that utilizes Boolean logic.

9. A system for providing assistance to emergency personnel as described in claim 1 that utilizes temperature sensing.

10. A system for providing assistance to emergency personnel as describing claim 1 that includes at least one thermistor.

11. A system for providing assistance to emergency personnel as describing claim 10 that includes a plurality of thermistors.

12. A system for providing assistance to emergency personnel as described in claim 4 further including structure for determining the last known good position information.

13. A system for providing assistance to emergency personnel as described in claim 1 wherein said means for detecting includes ultrasonic apparatus.

14. A system for providing assistance to emergency personnel as described in claim 1 includes microwave apparatus.

15. A system for providing assistance to emergency personnel as described in claim 1 that includes infrared sensing.

16. A system for providing assistance to emergency personnel as described in claim 1 that includes both passive infrared and microwave sensors.

17. A system for providing assistance to emergency personnel as described in claim 1 wherein said means responsive to said means for detecting for displaying the location of personnel within protected premises relies on a logic circuit for responsiveness.

18. A system for providing assistance to emergency personnel as described in claim 1 wherein said means responsive to said means for detecting for displaying the location of personnel within protected premises relies on a microprocessor for responsiveness.

19. A system for providing assistance to emergency personnel as described in claim 1 wherein the means for displaying the location of personnel within protected premises includes a floor plan on which the locations are defined.

20. A system for providing assistance to emergency personnel as describing claim 1 wherein the means for displaying includes wireless means for remotely displaying the location of personnel within protected premises.

21. A system for providing assistance to emergency personnel which comprises:
means for detecting the presence of personnel within a protected premises and means for storing the location of personnel within protected premises that includes nonvolatile memory and which is capable of storing such data for a plurality of time periods;
means for detecting an imminent threat selected from the group consisting of a fire, seismological and terrorist events;
means, responsive to the means for detecting, for displaying the location of personnel within protected premises.

22. A system for providing assistance to emergency personnel as described in claim 21 wherein said means for detecting an imminent threat utilizes portions selected from the group consisting of an ionization-type detector, a photoelectric detector, fuzzy logic, Boolean logic, temperature sensing, and at least one thermistor.

23. A system for providing assistance to emergency personnel as described in claim 22 further including structure for determining the last known good position information.

24. A system for providing assistance to emergency personnel as described in claim 21 wherein said means for detecting includes ultrasonic apparatus.

25. A system for providing assistance to emergency personnel as described in claim 21 wherein said means includes microwave apparatus.

26. A system for providing assistance to emergency personnel as described in claim 21 wherein said means for detecting includes infrared sensing.

27. A system for providing assistance to emergency personnel as described in claim 21 that includes both passive infrared and microwave sensors.

28. A system for providing assistance to emergency personnel as described in claim 21 wherein said means responsive to said means for detecting for displaying the location of personnel within protected premises relies on a logic circuit for responsiveness.

29. A system for providing assistance to emergency personnel as described in claim 21 wherein said means responsive to said means for detecting for displaying the location of personnel within protected premises relies on a microprocessor for responsiveness.

30. A system for providing assistance to emergency personnel as described in claim 21 wherein the means for displaying the location of personnel within a protected premises includes a floor plan on which the locations are defined.

31. A system for providing assistance to emergency personnel as describing claim 21 wherein the means for displaying includes wireless means for remotely displaying the location of personnel within protected premises.

32. A system for providing assistance to emergency personnel as describing claim 21 wherein the means for displaying includes a graphic keypad and a security panel that allows selective visual monitoring and selective audio monitoring of a plurality of locations within protected premises.

33. A system for providing assistance to emergency personnel which comprises:
means for detecting the presence of personnel within a protected premises and means for storing the location of personnel within protected premises that includes nonvolatile memory and which is capable of storing such data for a plurality of time periods;
means for detecting an imminent threat that utilizes at least one portion selected from the group consisting of an ionization-type detector, a photoelectric detector, fuzzy logic, Boolean logic, temperature sensing, at least one thermistor, ultrasonic apparatus, microwave apparatus, and infrared sensing;
means, responsive to the means for detecting, for displaying the location of personnel within protected premises that includes portions selected from the group selected from the group consisting of a logic circuit, a microprocessor, a floor plan on which the locations are defined, wireless means for remotely displaying the location of personnel within protected premises and a graphic keypad and a security panel that allows selective visual monitoring and selective audio monitoring of a plurality of locations within protected premises.

34. A method for providing assistance to emergency personnel which includes:
detecting the presence of personnel within a protected premises;
detecting an imminent threat selected from the group consisting of a fire, seismological and terrorist events;
displaying the location of personnel within protected premises when an imminent threat is detected.

35. A method for providing assistance to emergency personnel as described in claim 34 further including the step of storing the location of personnel within protected premises.

36. A method for providing assistance to emergency personnel as described in claim 34 wherein the step of storing the location of personnel nonvolatile memory.

37. A method for providing assistance to emergency personnel as described in claim 36 wherein the step of storing the location of personnel includes the step of storing data for personnel within a protected premises for each of a plurality of time periods.

38. A method for providing assistance to emergency personnel as described in claim 34 wherein the step of detecting an imminent threat includes providing apparatus that includes a complement selected from (a.) ionization-type detector, (b) a photoelectric detector, (c) fuzzy logic, (d) Boolean logic, (e) temperature sensing, (f) ultrasonic apparatus, (g) at least one thermistor, (h) microwave apparatus and (i) infrared sensing.

39. A method for providing assistance to emergency personnel as described in claim 34 further including the step of determining the last known good position information.
